(19) United States
(12) Patent Application Publication
(10) Pub. No.: US 2024/0281435 A1
(43) Pub. Date: Aug. 22, 2024

(54) DATABASE SELF-OPTIMIZATION USING PREDICTED VALUES FOR ACCESS PATHS

(71) Applicant: INTERNATIONAL BUSINESS MACHINES CORPORATION, Armonk, NY (US)

(72) Inventors: Xiao Xiao CHEN, Beijing (CN); Peng Hui JIANG, Beijing (CN); Sheng Yan SUN, Beijing (CN); Ying ZHANG, Beijing (CN)

(21) Appl. No.: 18/111,083

(22) Filed: Feb. 17, 2023

(51) Int. Cl. G06F 16/242; G06F 16/28

(52) U.S. Cl. CPC G06F 16/2433; G06F 16/285

(57) ABSTRACT

A method, system, and computer program product that are configured to: receive a Structured Query Language (SQL) statement including placeholders; generate sets of predicted values for the placeholders; generate candidate access paths in a database using the sets of predicted values; receive a query including the SQL statement with actual values instead of the placeholders; select one of the candidate access paths based on determining similarities of the actual values to ones of the sets of predicted values; in response to the selected one of the candidate access paths being acceptable, execute the query using the selected one of the candidate access paths; and in response to the selected one of the candidate access paths not being acceptable, generate a new access path in the database using the actual values, and execute the query using the new access path.

### BACKGROUND

Aspects of the present invention relate generally to relational databases and, more particularly, to generating database access paths using predicted values.

A relational database can be configured to represent data in relation to other data. For example, a relational database can represent data in tabular form, i.e., tables of sets of rows and columns. Additionally, the relational database can be configured to store and retrieve data using a set of relational operators that work with the tables. Further, computer applications can be configured to access the data in relational databases using these operators. More specifically, the computer applications can be configured to access data according to a predetermined access path.

### SUMMARY

In a first aspect of the invention, there is a computer-implemented method including: receiving, by a processor set, a Structured Query Language (SQL) statement including placeholders; generating, by the processor set, sets of predicted values for the placeholders; generating, by the processor set, candidate access paths in a database using the sets of predicted values; receiving, by the processor set, a query including the SQL statement with actual values instead of the placeholders; selecting, by the processor set, one of the candidate access paths based on determining similarities of the actual values to ones of the sets of predicted values; in response to the selected one of the candidate access paths being acceptable, executing the query using the selected one of the candidate access paths; and in response to the selected one of the candidate access paths not being acceptable, generating a new access path in the database using the actual values, and executing the query using the new access path.

In another aspect of the invention, there is a computer program product including one or more computer readable storage media having program instructions collectively stored on the one or more computer readable storage media. The program instructions are executable to: receive a Structured Query Language (SQL) statement including placeholders; generate sets of predicted values for the placeholders; generate candidate access paths in a database using the sets of predicted values; receive a query including the SQL statement with actual values instead of the placeholders; select one of the candidate access paths based on determining similarities of the actual values to ones of the sets of predicted values; in response to the selected one of the candidate access paths being acceptable, execute the query using the selected one of the candidate access paths; and in response to the selected one of the candidate access paths not being acceptable, generate a new access path in the database using the actual values, and execute the query using the new access path.

In another aspect of the invention, there is a system including a processor set, one or more computer readable storage media, and program instructions collectively stored on the one or more computer readable storage media. The program instructions are executable to: receive a Structured Query Language (SQL) statement including placeholders; generate sets of predicted values for the placeholders; generate candidate access paths in a database using the sets of predicted values; receive a query including the SQL statement with actual values instead of the placeholders; select one of the candidate access paths based on determining similarities of the actual values to ones of the sets of predicted values; in response to the selected one of the candidate access paths being acceptable, execute the query using the selected one of the candidate access paths; and in response to the selected one of the candidate access paths not being acceptable, generate a new access path in the database using the actual values, and execute the query using the new access path.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows an exemplary query in the form of a Structured Query Language (SQL) statement with placeholders in accordance with aspects of the present invention.

FIG. 4 shows an example of generating sets of predicted values for the placeholders in the SQL statement using a time series forecasting model in accordance with aspects of the present invention.

FIG. 5 shows a table of exemplary values of the sets of predicted values generated by the time series forecasting model in accordance with aspects of the present invention.

FIG. 6 shows the query of FIG. 3 with one of the sets of precited values instead of the placeholders in accordance with aspects of the present invention.

FIG. 7 shows a table of determined filterability values for each of the predicted values of each set of predicted values in accordance with aspects of the present invention.

FIG. 8 shows filterability vectors that include the determined filterability values from the table of FIG. 7 in accordance with aspects of the present invention.

FIG. 9 shows an example of determining a center point and an isolated point of the filterability vectors in accordance with aspects of the present invention.

FIG. 10 shows exemplary candidate access paths generated for the center point and the isolated point in accordance with aspects of the present invention.

FIG. 11 shows a flowchart of an exemplary method in accordance with aspects of the present invention.

FIG. 12 shows a continuation of the example of FIG. 9 in accordance with aspects of the present invention.

FIG. 13 depicts portability of the system in accordance with aspects of the present invention.

FIG. 14 shows a flowchart of an exemplary method in accordance with aspects of the present invention.

### DETAILED DESCRIPTION

Aspects of the present invention relate generally to relational databases and, more particularly, to generating database access paths using predicted values. Software engineers can configure computer applications to manipulate data in databases by writing and executing code, such as Structured Query Language (SQL). Queries received by a database can take the form of query statements such as SQL statements. A database can generate an access path for an SQL statement to specify how the database accesses the data that the query specifies. The access path can specify the indexes and tables that are accessed, the access methods that are used, and the order in which objects are accessed.

A question mark (“?”) in an SQL statement is a placeholder that represents a value that will be provided when a subsequent query using the SQL statement is executed. A user can pass an SQL statement including questions marks into a database to generate an access path that can be re-used with successive queries that use the same SQL statement with actual values in place of the question marks. Doing so allows the database to re-use the same access path for plural different queries, which reduces compilation time by reducing the number of times the database generates an access path. However, an access path generated in this manner produces suboptimal results when the question mark is in a WHERE clause in the SQL statement. In particular, an access path generated for an SQL statement with a question mark in a WHERE clause can cause inaccurate results to be returned when a subsequent query is run with an actual value in place of the question mark. One solution to address the degraded performance caused by this issue is to consult with an expert who can diagnose the problem and force the query to use a different access path; however, this is time consuming and can have a business impact on an online transaction processing database (OLTP). Another solution to address the degraded performance caused by this issue is to force the database to re-generate a new access path each time a query is run with this SQL statement; however, this increases the compile load on the database since it negates the benefit of reusing a same access path for plural subsequent queries.

Implementations of the invention address this problem by providing a self-optimized method for a database to handle different workloads posed by SQL statements that contain a question mark in a WHERE clause. In embodiments, the method includes predicting values to be used in place of the question mark and generating candidate access paths using the predicted values. In embodiments, the predicted values are generated using a machine learning model such as a time series forecasting model learned using log data from the database. By generating the candidate access paths using predicted values that are based on historical usage of the database, the candidate access paths are more likely to be better performing for subsequent queries that contain actual values for the question marks compared to an access path that is generated for the SQL statement containing the question marks. In embodiments, the method generates plural sets of predicted values and plural candidate access paths, and selects one of the plural candidate access paths to use with a subsequent query based on comparing a similarity of the sets of precited values to the actual values included in the subsequent query. In this manner, the method identifies and selects the best one of the plural candidate access paths for each subsequent query. In embodiments, in response to determining that none of the plural sets of predicted values is sufficiently similar to the actual values used in a subsequent query, the method generates a new access path using the actual values in the query. In this manner, implementations of the invention provide an improvement in the field of database operations. The improvement is technical because it affects how a relational database operates to generate access paths for SQL statements that include a question mark in a WHERE clause.

As will be understood from this disclosure, aspects of the present invention provide a method for building a self-optimized model for handling question mark inputs of WHERE clauses in SQL statements of a relational database, the method including: predicting input values in WHERE clauses by a time series forecasting model based on historical data from logs; estimating filterability for each WHERE clause; selecting sets of predicted values to generate candidate access paths; generating candidate access paths for the SQL statement using the predicted values in the WHERE clause; and selecting an optimal access path when the query runs with actual values in place of the question marks in the WHERE clause. In embodiments, the selecting the optimal access path includes: determining a filterability of each WHERE clause with actual (e.g., passed in) values; calculating a distance between a filterability vector of the actual values and filterability vectors of the candidate access paths; in response to the distance being acceptable, using the optimal access path; and in response to the distance not being acceptable, generating a new access path based on the actual values, and storing the new access path and filterability vector. In this manner, implementations of the invention ensure good performance when handling an SQL query under various inputs of WHERE clauses. In this manner, implementations of the invention also decrease compile time for handling subsequent SQL queries. In this manner, implementations of the invention also avoid poor performance when handling SQL statements that include a question mark in a WHERE clause and, thus, reduce a number of resources used in diagnosing and resolving problems associated with handling SQL statements that include a question mark in a WHERE clause.

It should be understood that, to the extent implementations of the invention collect, store, or employ personal information provided by or obtained from individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as access path optimizing code shown at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

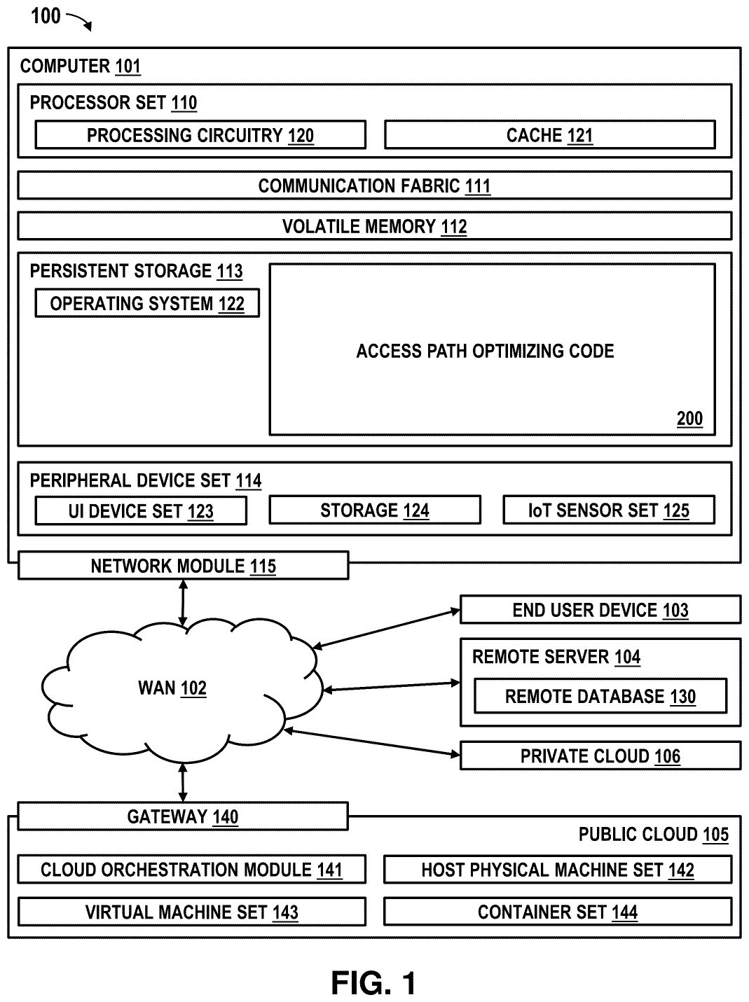

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

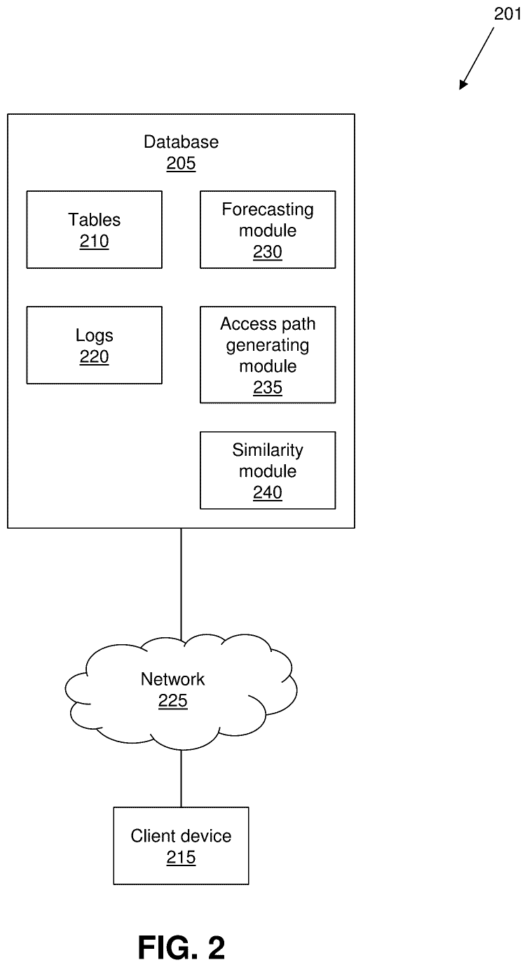

FIG. 2 shows a block diagram of an exemplary environment 201 in accordance with aspects of the present invention. In embodiments, the environment includes a database 205 comprising tables 210 that contain data that may be queried by a client device 215 using SQL statements. In embodiments, the database 205 comprises logs 220 that contain historical usage data related to the database 205 such as statistics and data related to previously executed queries. The client device 215 communicates with the database 205 via network 225. In one example, the database 205 comprises one or more instances of the computer 101 of FIG. 1, the client device 215 comprises one or more instances of end user device 103 or remote server 104 of FIG. 1, and the network 225 comprises the WAN 102 of FIG. 1.

In embodiments, the database 205 of FIG. 2 comprises forecasting module 230, access path generating module 235, and similarity module 240, each of which may comprise modules (e.g., program modules) of the access path optimizing code of block 200 of FIG. 1. These modules of the code of block 200 are executable by the processing circuitry 120 of FIG. 1 to perform the inventive methods as described herein. The database 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, the forecasting module 230 is configured to generate predicted values for a placeholder in a clause of an SQL statement. In embodiments, the SQL statement is received from the client device 215 and the placeholder is one or more question marks (“?”) in a WHERE clause of the SQL statement. In embodiments, the forecasting module 230 generates sets of predicted values for the question marks in the WHERE clause of the SQL statement using a machine learning model that is trained using data from the logs 220. In embodiments, the machine learning model is a time series forecasting model that is trained using time series data from the logs 220. In embodiments, the time series data includes data that defines historical queries executed by the database 205, including timestamps of the queries, historical input values for the queries (e.g., values used in place of question marks each query), customer segments or attributes references by a workload, and identifiers of ones of the tables 210 accessed by the queries. Non-limiting examples of types of time series forecasting models that can be used in embodiments include ARIMA (Auto Regressive Integrated Moving Average) and SARIMA (Seasonal ARIMA) models.

In accordance with aspects of the present invention, the access path generating module 235 is configured to generate candidate access paths using the sets of predicted values generated by the forecasting module 230. The access path generating module 235 may generate the candidate access paths using conventional or later developed techniques.

In accordance with aspects of the present invention, the similarity module 240 is configured to identify an optimal one of the candidate access paths based on actual values received in a query using the SQL statement. In embodiments, the similarity module 240 determines a similarity between actual values used in a query and sets of predicted values used in generating the candidate access paths. In embodiments, the similarity module 240 determines a respective filterability vector for each set of predicted values and for the actual values used in the query. In embodiments, the similarity module 240 determines a respective similarity between (1) the filterability vector for the actual values used in the query and (2) each of the respective filterability vectors for the sets of predicted values. In embodiments, the similarity module 240 uses the determined similarities to identify and select the set of predicted values that are more similar to the actual values. In embodiments, the similarity module 240 determines whether the selected set of predicted values are sufficiently similar to the actual values, which may be performed using a predefined threshold. In response to determining that the selected set of predicted values are sufficiently similar to the actual values (e.g., satisfactory), the database 205 executes the query using the candidate access path that corresponds to the selected set of predicted values, which is deemed the optimal candidate access path. In response to determining that the selected set of predicted values are not sufficiently similar to the actual values (e.g., not satisfactory), the database 205 generates a new access path using the actual values of the query and executes the query using the new access path.

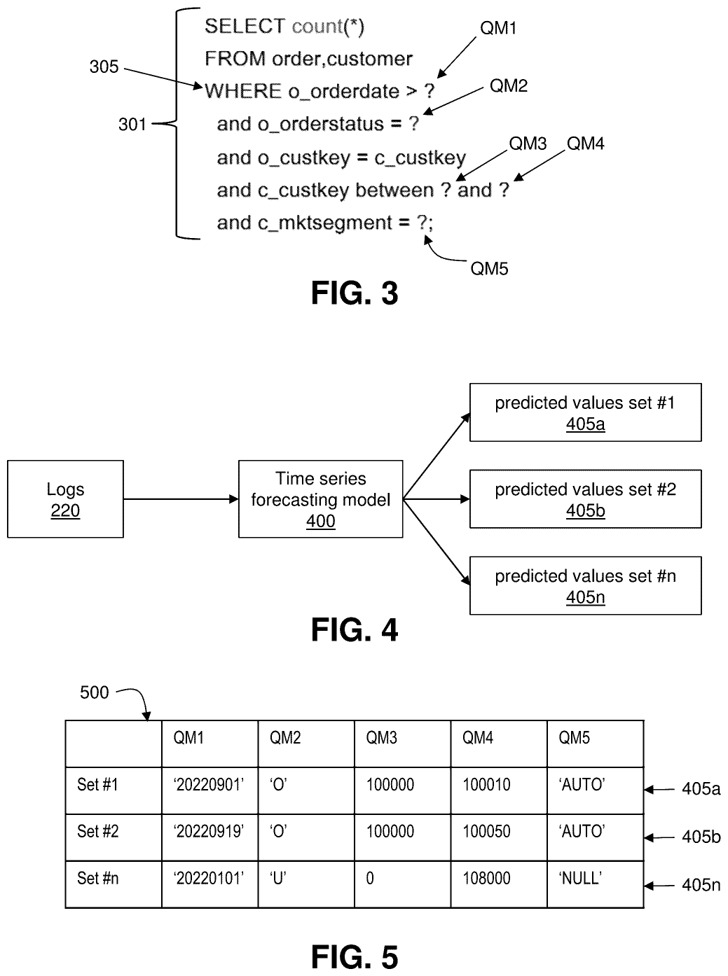

FIGS. 3-11 depict an example use case that illustrates aspects of the present invention. The exemplary data shown in FIGS. 3-11 is for explaining aspects of the present invention and is not limiting.

FIG. 3 shows an exemplary query in the form of a Structured Query Language (SQL) statement with placeholders in accordance with aspects of the present invention. The query 301 is in the form of an SQL statement that includes a WHERE clause 305. In this example, the WHERE clause 305 includes five question marks QM1, QM2, QM3, QM4, QM5, which are placeholders. In embodiments, the query 301 is generated by the client device 215 of FIG. 2 and transmitted to the database 205 via the network 225.

FIG. 4 shows an example of generating sets of predicted values for the question marks in the query 301 using a time series forecasting model 400 in accordance with aspects of the present invention. In embodiments, the forecasting module 230 uses the data from the logs 220 of FIG. 2 with the time series forecasting model 400 to generate sets of predicted values 405a, 405b, . . . , 405n for the question marks QM1, QM2, QM3, QM4, QM5 in the query 301 of FIG. 3. As described herein, the time series forecasting model 400 uses historic time series data of the database 205, captured in the logs 220, to predict values of question marks in a query. In one example, for a particular query, different values in the WHERE clause may have been historically passed into the database 205 for different workloads at different dates and times. This historic data is saved in the logs 220. Therefore, for a particular workload, the forecasting module 230 may gather historic data of the workload from the logs 220, extract features from the gathered historic data (e.g., historical input values for a query, customer segments or attributes referenced by the workload, etc.), and train the time series forecasting model 400 using the extracted features. The time series forecasting model 400 trained in this manner may be used to predict values of question marks included in WHERE clauses. In embodiments, the time series forecasting model 400 generates ‘n’ number of different sets of predicted values.

FIG. 5 shows a table 500 of exemplary values of the sets of predicted values 405a-n generated by the time series forecasting model 400 of FIG. 4. In this example, a first set of predicted values 405a, indicated in the row labeled Set #1, includes the predicted value 20220901 for QM1, ‘O’ for QM2, 100000 for QM3, 100010 for QM4, and ‘AUTO’ for QM5. In this example, a second set of predicted values 405b, indicated in the row labeled Set #2, includes the predicted value 20220919 for QM1, ‘O’ for QM2, 100000 for QM3, 100050 for QM4, and ‘AUTO’ for QM5. In this example, an n-th set of predicted values 405n, indicated in the row labeled Set #n, includes the predicted value 20220101 for QM1, ‘U’ for QM2, 0 for QM3. 108000 for QM4, and ‘NULL for QM5. There may be any number ‘n’ of sets of predicted values, and the value of the number ‘n’ may be a configurable feature set by user input to the database 205.

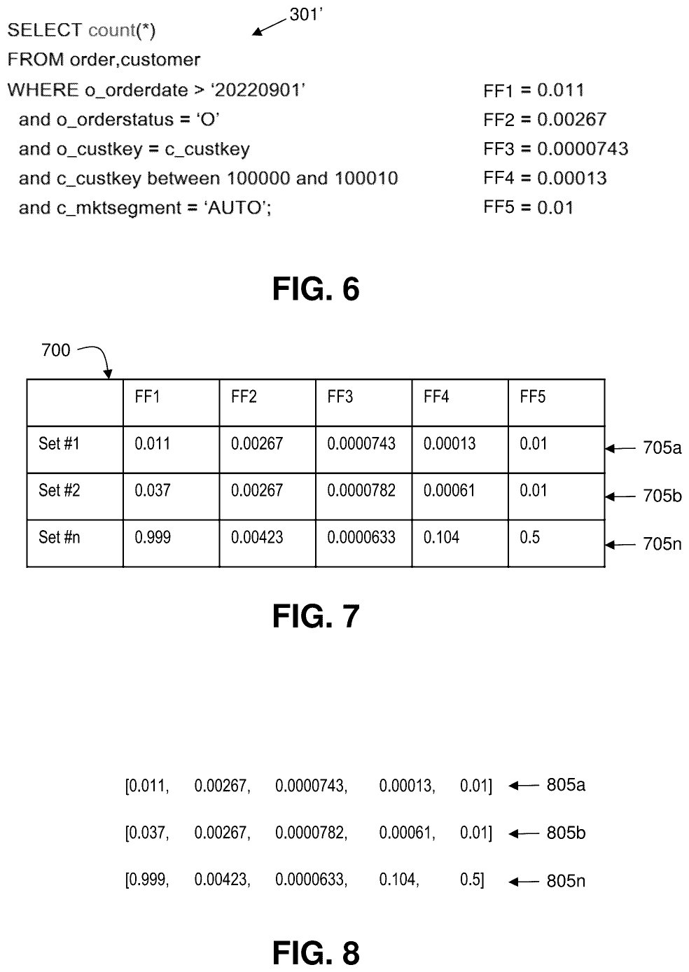

FIG. 6 shows the query 301′ of FIG. 3 with the precited values of the first set 405a in place of the question marks QM1, QM2, QM3, QM4, QM5. FIG. 6 also shows filter factors FF1, FF2, FF3, FF4, FF5 determined based on the statistics of the database 205 and the predicted values. The filter factor is also referred to as filterability and may be determined using conventional techniques based on database statistics and a value used in a WHERE clause in an SQL statement. For example, the database 205 can collect statistics on objects such as tables, columns, and indexes. For each condition in a WHERE clause, the database 205 can estimate the filter factor (aka filterability) based on the statistics and predicted values. In this example, for this query 301′, the clause o_orderdate >‘20220901’ (using the predicted value of 20220901 in the place of QM1) has a determined filterability FF1=0.011 based on the statistics of this database 205. Similarly, for this query 301′, the predicted value of ‘O’ in the place of QM2 has a determined filterability of 0.00267, the predicted value of 100000 in the place of QM3 has a determined filterability of 0.0000743, the predicted value of 100010 in the place of QM4 has a determined filterability of 0.00013, and the predicted value of ‘AUTO’ in the place of QM5 has a determined filterability of 0.01.

FIG. 7 shows a table 700 of determined filterability values for each of the predicted values of each set of predicted values from table 500 of FIG. 5. For example, row 705a shows the set of determined filterability values for the first set of predicted values 405a of FIG. 5. Similarly, row 705b shows the set of determined filterability values for the second set of predicted values 405b of FIG. 5, and row 705n shows the set of determined filterability values for the n-th set of predicted values 405n of FIG. 5. In embodiments, the similarity module 240 determines the filterability values.

FIG. 8 shows filterability vectors 805a, 805b, . . . , 805n that include the determined filterability values from the table 700 of FIG. 7. For example, filterability vector 805a includes the filterability values of row 705a, filterability vector 805b includes the filterability values of row 705b, and filterability vector 805n includes the filterability values of row 705n. In embodiments, the similarity module 240 generates the filterability vectors.

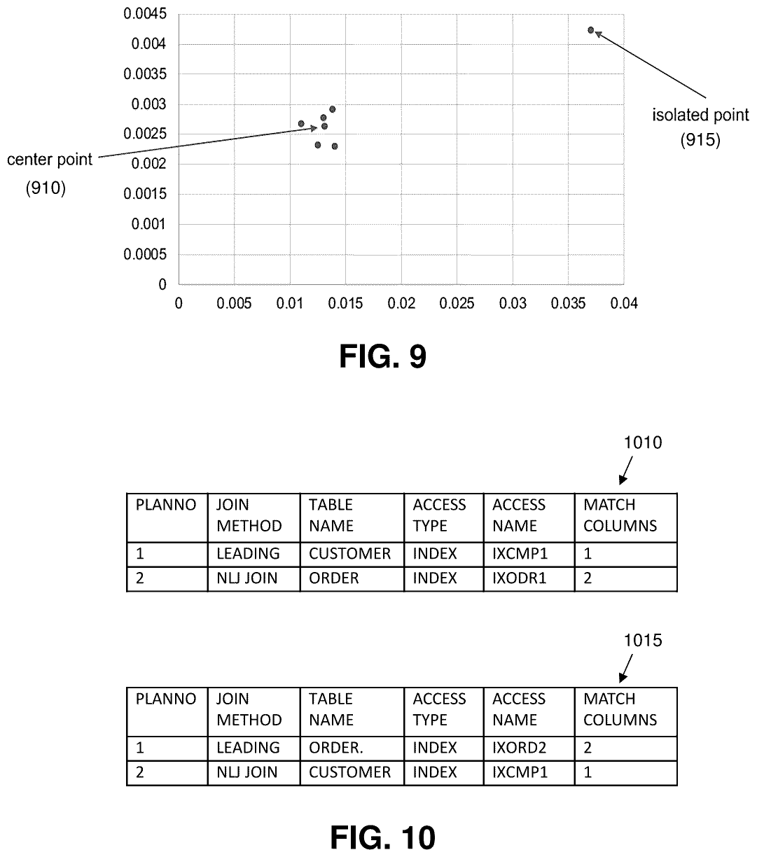

FIG. 9 shows an example of determining a center point 910 and an isolated point 915 of the filterability vectors 805a-n in accordance with aspects of the present invention. In embodiments, the similarity module 240 uses a clustering algorithm to perform a clustering of the filterability vectors 805a-n. In embodiments, the similarity module 240 determines a center point 910 and an isolated point 915 of the clustered filterability vectors 805a-n. In embodiments, the center point 910 corresponds to the one of the filterability vectors 805a-n that has the shortest vector distance to all other ones of the filterability vectors 805a-n, and the isolated point 915 corresponds to the one of the filterability vectors 805a-n that has the longest vector distance to all other ones of the filterability vectors 805a-n. In the example shown in FIG. 9, the number ‘n’ equals seven, such that there are seven points corresponding to seven filterability vectors 805a-n in the cluster, meaning that in this example there are seven sets of predicted values 405a-n corresponding to the seven filterability vectors 805a-n. In one example, the similarity module 240 uses a k-means clustering algorithm to determine the center point 910 and the isolated point 915, although other clustering algorithms may be used.

FIG. 10 shows exemplary candidate access paths generated for the center point and the isolated point determined using the clustering. In embodiments, access path 1010 is generated using the set of predicted values that correspond to the center point 910, and access path 1015 is generated using the set of predicted values that correspond to the isolated point 915. In the example shown in FIG. 9, the center point 910 corresponds to the filterability vector 805a which corresponds to the set of predicted values 405a. As such, the similarity module 240 passes the set of predicted values 405a to the access path generating module 235, which generates the access path 1010 based on this set of precited values 405a. In the example shown in FIG. 9, the isolated point 915 corresponds to the filterability vector 805n which corresponds to the set of predicted values 405n. As such, the similarity module 240 passes the set of predicted values 405n to the access path generating module 235, which generates the access path 1015 based on this set of precited values 405n. In embodiments, the database 205 stores the access path 1010 with the filterability vector 805a and the corresponding set of precited values 405a. Similarly, the database 205 stores the access path 1015 with the filterability vector 805n and the corresponding set of precited values 405n. The access paths 1010, 1015 are referred to as candidate access paths because they are candidates for using to execute a subsequent instance of query 301 that contains actual values in the place of the question marks QM1, QM2, QM3, QM4, QM5.

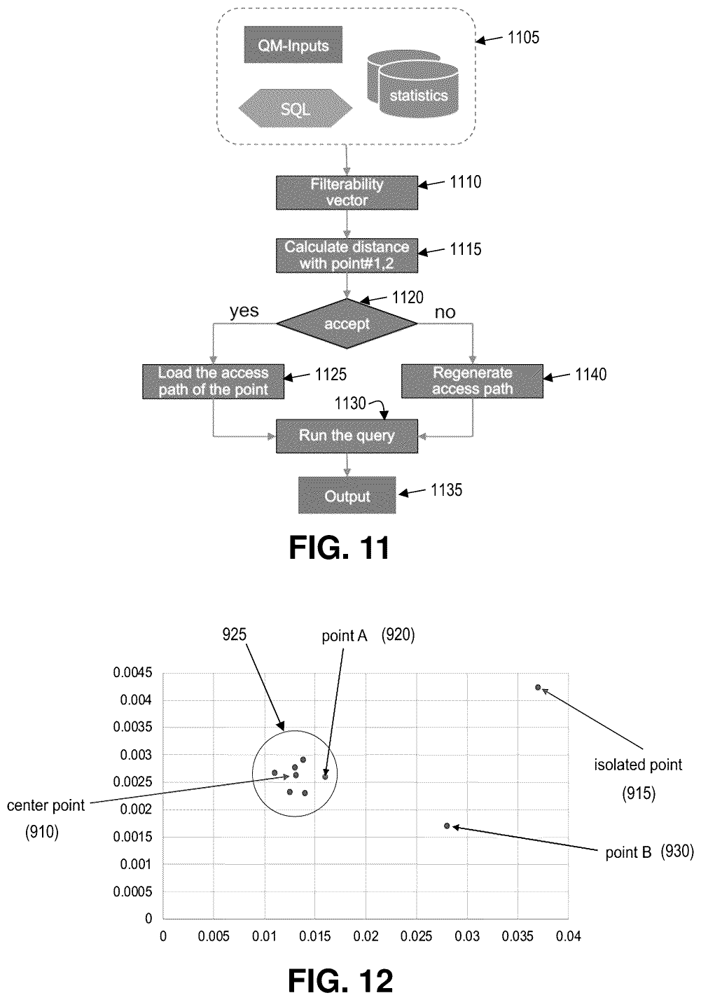

FIG. 11 shows a diagram of an exemplary flow after the database has created and saved the candidate access paths, such as access paths 1010, 1015 of FIG. 10. At step 1105, the database 205 receives a subsequent instance of the query 301 that contains actual values in the place of the question marks QM1, QM2, QM3, QM4, QM5. At step 1110, the database 205 determines a filterability vector for the set of actual values in a similar manner as was used to determine the respective filterability vectors 805a-n for the respective sets of precited values 405a-n. At step 1115, the database 205 calculates a vector distance between the filterability vector of the set of actual values and each of (1) the filterability vector of the set of predicted values that corresponds to the center point 910 and (2) the filterability vector of the set of predicted values that corresponds to the isolated point 915. At step 1120, the database 205 selects the shorter of the two vector distances calculated at step 1115 and determines whether to accept the candidate access path associated with the selected vector distance by comparing the selected vector distance to a predefined threshold. If the selected vector distance is less than the threshold at step 1120, then the database 205 accepts the candidate access path associated with the selected vector distance and at step 1125 loads the candidate access path for execution of the query. At step 1130, the database 205 runs (e.g., executes) the query from step 1105 using the candidate access path loaded at step 1125. At step 1135, the database 205 returns the result of the query to the client device 215. If the selected vector distance is greater than the threshold at step 1120, then the database 205 does not accept the candidate access path associated with the selected vector distance. Then at step 1140 the database 205 generates a new access path using the actual values in the query from step 1105. At step 1130, the database runs (e.g., executes) the query from step 1105 using the new access path loaded at step 1140. At step 1135, the database 205 returns the result of the query to the client device.

FIG. 12 shows a continuation of the example of FIG. 9. In FIG. 12, point A 920 corresponds to a clustered point for a filterability vector generated for actual values of a first subsequent instance of the query 301. In embodiments, the similarity module 240 determines a similarity between the actual values of the query and the set of precited values corresponding to the center point 910, and a similarity between the actual values of the query and the set of precited values corresponding to the isolated point 915. In embodiments, the similarity module 240 determines these similarities based on the filterability vectors corresponding to the center point 910, the isolated point 915, and point A 920. Using clustering with the filterability vectors corresponding to the center point 910, the isolated point 915, and point A 920, the similarity module 240 determines that point A 920 is closer to (e.g., more similar to) the center point 910 than to the isolated point 915. Based on this determination, the similarity module 240 selects the set of predicted values associated with the center point 910 as being more similar to the actual values used in the first subsequent instance of the query 301. In this example, the similarity module 240 determines that the similarity between the actual values and the selected set of predicted values is acceptable based on determining that the vector distance between point A 920 and the center point 910 is less than a threshold distance defined by an area 925. Based on determining the similarity is acceptable, the database 205 then uses the candidate access path 1010 associated with the selected set of predicted values (i.e., the set of predicted values corresponding to center point 910) to execute the first subsequent instance of the query 301.

Still referring to the example of FIG. 12, point B 930 corresponds to a clustered point for a filterability vector generated for actual values of a second subsequent instance of the query 301. In embodiments, the similarity module 240 determines a similarity between the actual values of this second query and the set of precited values corresponding to the center point 910, and a similarity between the actual values of this second query and the set of precited values corresponding to the isolated point 915. In embodiments, the similarity module 240 determines these similarities based on the filterability vectors corresponding to the center point 910, the isolated point 915, and point B 930. Using clustering with the filterability vectors corresponding to the center point 910, the isolated point 915, and point B 930, the similarity module 240 determines that point B 930 is closer to (e.g., more similar to) the isolated point 915 than to the center point 910. Based on this determination, the similarity module 240 selects the set of predicted values associated with the isolated point 915 as being more similar to the actual values used in the second subsequent instance of the query 301. In this example, the similarity module 240 determines that the similarity between the actual values and the selected set of predicted values is not acceptable based on determining that the vector distance between point B 930 and the isolated point 915 is greater than the predefined threshold distance (e.g., the same as that shown at area 925). Based on determining the similarity is not acceptable, the database 205 then generates a new access path based on the actual values of the second subsequent instance of the query 301, and uses this new access path to execute the second subsequent instance of the query 301.

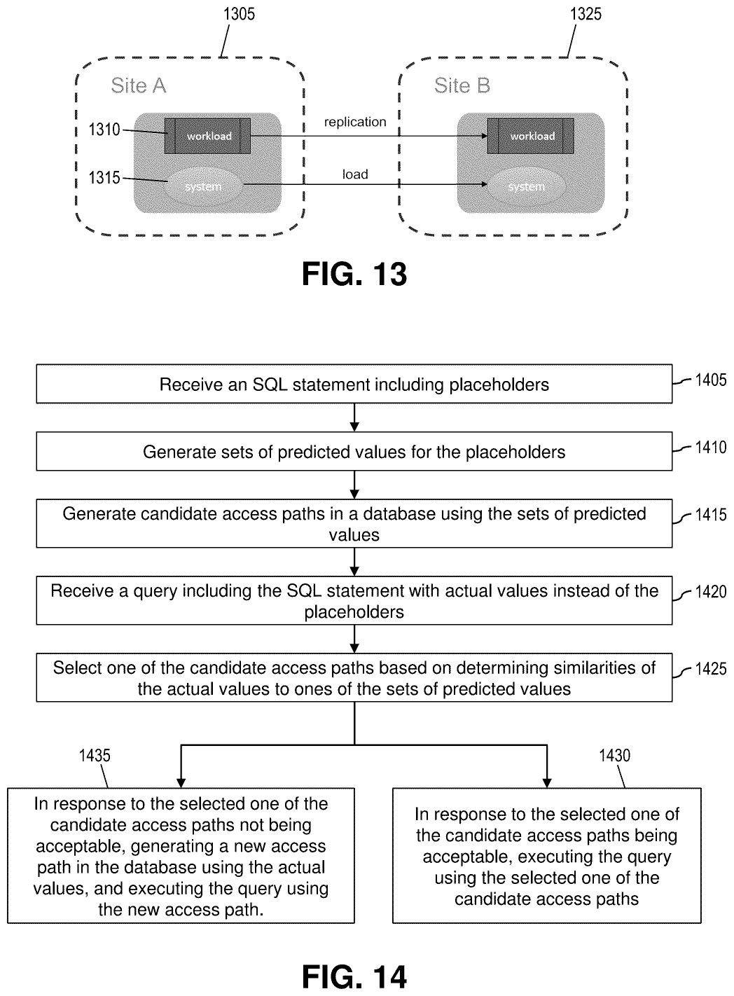

FIG. 13 depicts portability of the system in accordance with aspects of the present invention. In embodiments, the system can be applied after one site deploys the same workload with another site. For example, FIG. 13 shows a first site 1305 (Site A) with workload 1310 and system 1315. If a second site 1325 (Site B) needs to run the same workload, then the system 1315 in the first site 1305 can be used directly in the second site 1325.

FIG. 14 shows a flowchart of an exemplary method in accordance with aspects of the present invention. Steps of the method may be carried out in the environment of FIG. 2 and are described with reference to elements depicted in FIG. 2.

At step 1405, the system receives an SQL statement including placeholders. In embodiments, and as described with respect to FIGS. 2 and 3, the SQL statement includes a “WHERE” clause that includes question marks as placeholders.

At step 1410, the system generates sets of predicted values for the placeholders. In embodiments, and as described with respect to FIGS. 3-5, the forecasting module 230 generates ‘n’ number of different sets of predicted values for the placeholders using the time series forecasting model 400.

At step 1415, the system generates candidate access paths in a database using the sets of predicted values. In embodiments, and as described with respect to FIG. 9, the access path generating module 235 generates candidate access paths 1010 and 1015.

At step 1420, the system receives a query including the SQL statement with actual values instead of the placeholders. In embodiments, and as described with respect to FIGS. 11 and 12, the database 205 receives a query from a client device 215, the query including the SQL statement with actual values instead of the placeholders.

At step 1425, the system selects one of the candidate access paths based on determining similarities of the actual values to ones of the sets of predicted values. In embodiments, and as described with respect to FIGS. 10-12, the similarity module 240 selects one of the candidate access paths 1010, 1015.

At step 1430, in response to the selected one of the candidate access paths being acceptable, the system executes the query using the selected one of the candidate access paths.

At step 1435, in response to the selected one of the candidate access paths not being acceptable, the system generates a new access path in the database using the actual values, and executes the query using the new access path.

With continued reference to the method of FIG. 14, in embodiments each of the placeholders comprises a question mark “?” in a “WHERE” clause in the SQL statement.

With continued reference to the method of FIG. 14, in embodiments the generating the sets of predicted values is performed using a time series forecasting model 400 with historic data of the database, such as logs 220.

With continued reference to the method of FIG. 14, in embodiments the method further comprises: generating respective filterability vectors (e.g., 805a-n) of the sets of predicted values; generating a filterability vector of the actual values; and determining the similarities of the actual values to ones of the sets of predicted values using the respective filterability vectors of the sets of predicted values and the filterability vector of the actual values (e.g., using clustering as shown in FIG. 12).

With continued reference to the method of FIG. 14, in embodiments the method further comprises determining a center point (e.g., 910) and an isolated point (e.g., 915) of the respective filterability vectors of the sets of predicted values. In embodiments, the center point corresponds to a center point of a cluster of the respective filterability vectors of the sets of predicted values, and the isolated point corresponds to an isolated point of the cluster of the respective filterability vectors of the sets of predicted values. In embodiments, the selected one of the candidate access paths corresponds to the one of the center point and the isolated point. In embodiments, the method further comprises determining whether the selected one of the candidate access paths is acceptable based on the filterability vector of the actual values being within a predefined distance (e.g., 925) to a selected one of the center point and the isolated point.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, a Structured Query Language (SQL) statement including placeholders;
generating, by the processor set, sets of predicted values for the placeholders;
generating, by the processor set, candidate access paths in a database using the sets of predicted values;
receiving, by the processor set, a query including the SQL statement with actual values instead of the placeholders;
selecting, by the processor set, one of the candidate access paths based on determining similarities of the actual values to ones of the sets of predicted values;
in response to the selected one of the candidate access paths being acceptable, executing the query using the selected one of the candidate access paths; and
in response to the selected one of the candidate access paths not being acceptable, generating a new access path in the database using the actual values, and executing the query using the new access path.

2. The method of claim 1, wherein each of the placeholders comprises a question mark “?” in a “WHERE” clause in the SQL statement.

3. The method of claim 1, wherein the generating the sets of predicted values is performed using a time series forecasting model with historic data of the database.

4. The method of claim 1, further comprising:
generating respective filterability vectors of the sets of predicted values;
generating a filterability vector of the actual values; and
determining the similarities of the actual values to ones of the sets of predicted values using the respective filterability vectors of the sets of predicted values and the filterability vector of the actual values.

5. The method of claim 4, determining a center point and an isolated point of the respective filterability vectors of the sets of predicted values.

6. The method of claim 5, wherein:
the center point corresponds to a respective center point of a cluster of the respective filterability vectors of the sets of predicted values; and
the isolated point corresponds to a respective isolated point of the cluster of the respective filterability vectors of the sets of predicted values.

7. The method of claim 5, wherein the selected one of the candidate access paths corresponds to one of the center point and the isolated point.

8. The method of claim 5, further comprising determining whether the selected one of the candidate access paths is acceptable based on the filterability vector of the actual values being within a predefined distance to a selected one of the center point and the isolated point.

9. A computer program product comprising one or more computer readable storage media having program instructions collectively stored on the one or more computer readable storage media, the program instructions executable to:
receive a Structured Query Language (SQL) statement including placeholders;
generate sets of predicted values for the placeholders;
generate candidate access paths in a database using the sets of predicted values;
receive a query including the SQL statement with actual values instead of the placeholders;
select one of the candidate access paths based on determining similarities of the actual values to ones of the sets of predicted values;
in response to the selected one of the candidate access paths being acceptable, execute the query using the selected one of the candidate access paths; and
in response to the selected one of the candidate access paths not being acceptable, generate a new access path in the database using the actual values, and execute the query using the new access path.

10. The computer program product of claim 9, wherein each of the placeholders comprises a question mark “?” in a “WHERE” clause in the SQL statement.

11. The computer program product of claim 9, wherein the generating the sets of predicted values is performed using a time series forecasting model with historic data of the database.

12. The computer program product of claim 9, wherein the program instructions are executable to:
generate respective filterability vectors of the sets of predicted values;
generate a filterability vector of the actual values; and
determine the similarities of the actual values to ones of the sets of predicted values using the respective filterability vectors of the sets of predicted values and the filterability vector of the actual values.

13. The computer program product of claim 12, wherein the program instructions are executable to determine a center point and an isolated point of the respective filterability vectors of the sets of predicted values.

14. The computer program product of claim 13, wherein:
the center point corresponds to a respective center point of a cluster of the respective filterability vectors of the sets of predicted values; and
the isolated point corresponds to respective isolated point of the cluster of the respective filterability vectors of the sets of predicted values.

15. The computer program product of claim 13, wherein the selected one of the candidate access paths corresponds to one of the center point and the isolated point.

16. The computer program product of claim 13, wherein the program instructions are executable to determine whether the selected one of the candidate access paths is acceptable based on the filterability vector of the actual values being within a predefined distance to a selected one of the center point and the isolated point.

17. A system comprising:
a processor set, one or more computer readable storage media, and program instructions collectively stored on the one or more computer readable storage media, the program instructions executable to:
receive a Structured Query Language (SQL) statement including placeholders;
generate sets of predicted values for the placeholders;
generate candidate access paths in a database using the sets of predicted values;
receive a query including the SQL statement with actual values instead of the placeholders;
select one of the candidate access paths based on determining similarities of the actual values to ones of the sets of predicted values;
in response to the selected one of the candidate access paths being acceptable, execute the query using the selected one of the candidate access paths; and
in response to the selected one of the candidate access paths not being acceptable, generate a new access path in the database using the actual values, and execute the query using the new access path.

18. The system of claim 17, wherein each of the placeholders comprises a question mark “?” in a “WHERE” clause in the SQL statement.

19. The system of claim 17, wherein the generating the sets of predicted values is performed using a time series forecasting model with historic data of the database.

20. The system of claim 17, wherein the program instructions are executable to:
generate respective filterability vectors of the sets of predicted values;
generate a filterability vector of the actual values; and
determine the similarities of the actual values to ones of the sets of predicted values using the respective filterability vectors of the sets of predicted values and the filterability vector of the actual values.
